(19) United States
(12) Patent Application Publication
(10) Pub. No.: US 2026/0022210 A1
(43) Pub. Date: Jan. 22, 2026

(54) MULTI-PART SPONGE-FORMING SILICONE RUBBER COMPOSITION

(71) Applicant: DOW TORAY CO., LTD., Shinagawa-Ku, Tokyo (JP)

(72) Inventor: Masakazu IRIE, Ichihara-Shi, Chiba (JP)

(21) Appl. No.: 19/114,174

(22) PCT Filed: Sep. 20, 2023
(86) PCT No.: PCT/JP2023/034008

§ 371 Date: Mar. 21, 2025

(30) Foreign Application Priority Data
Sep. 21, 2022 (JP) 2022-150302

(51) Int. Cl. C08G 77/20; C08G 77/00; C08G 77/12; C08G 77/16; C08J 9/00; C08J 9/28; C08K 7/26

(52) U.S. Cl. CPC C08G 77/20; C08G 77/12; C08G 77/16; C08J 9/0066; C08J 9/283; C08K 7/26; C08G 77/80; C08J 2201/0504; C08J 2383/05; C08J 2383/06; C08J 2383/07

(57) ABSTRACT

Provided is a multi-component sponge forming silicone rubber composition that has excellent storage stability and is mixed to form a sponge with fine and uniform open cells. The composition comprises liquids I to III, being mixed to form a composition containing (A) an organopolysiloxane having at least two alkenyl groups per molecule, (B) an organopolysiloxane having at least two silicon atom-bonded hydrogen atoms per molecule, (C) water, (D) a thickener, (E) a surfactant, (F) silica fine powder, (G) an organosiloxane oligomer having a silicon atom-bonded hydroxyl group, and (H) a hydrosilylation reaction catalyst. Liquid I contains components (A) and (H) and does not contain component (B), liquid II contains component (B) and does not contain component (H), liquid III contains components (C) and (D) and does not simultaneously contain components (B) and (H), and either liquid I or liquid II, which contains components (E) and (F), further contains component (G).

### TECHNICAL FIELD

The present invention relates to a multi-component sponge forming silicone rubber composition.

### BACKGROUND ART

Silicone rubber sponges have excellent heat resistance and weather resistance, in addition to being light weight, and are therefore used for: automobile parts; rollers and belts of copiers, printers, and other image forming devices; packings, gaskets, O-rings, and other various seal parts; and the like.

A known method for forming such a silicone rubber sponge involves uniformly dispersing water in a liquid silicone rubber composition and then removing the water after or while the composition is cured. Examples of sponge forming silicone rubber compositions used in this method include: sponge forming silicone rubber compositions including a diorganopolysiloxane having at least two silicon atom-bonded alkenyl groups per molecule, an organopolysiloxane having at least two silicon atom-bonded hydrogen atoms per molecule, water containing smectite clay, a silica filler, a nonionic surfactant, and a hydrosilylation reaction catalyst (see Patent Document 1); and sponge forming silicone rubber compositions including a diorganopolysiloxane blocked with alkenyl groups at both molecular chain ends and having no alkenyl groups on a molecular side chain, a diorganopolysiloxane having at least two alkenyl groups on a molecular side chain, an organopolysiloxane having at least two silicon atom-bonded hydrogen atoms per molecule, a mixture of water and smectite clay, a silica filler, a nonionic surfactant, a hydrosilylation reaction catalyst, and a curing retarder (see Patent Document 2).

During storage of such sponge forming silicone rubber compositions, it is a common practice to separate the compositions into at least three liquids: a component containing an alkenyl group-containing organopolysiloxane and a hydrosilylation reaction catalyst, but not containing a silicon atom-bonded hydrogen atom-containing organopolysiloxane; a component containing a silicon atom-bonded hydrogen atom-containing organopolysiloxane and not containing a hydrosilylation reaction catalyst; and a component containing water and smectite clay, but not containing either a silicon atom-bonded hydrogen atom-containing organopolysiloxane or a hydrosilylation reaction catalyst, and then to mix the three liquids during curing (see Patent Document 3).

However, with respect to these liquids, liquids that contain both a surfactant and a silica filler have the problem of increasing in viscosity over time. Furthermore, there is the problem that the compounding properties change due to the increase in viscosity, which in turn changes the properties of the obtained silicone rubber sponge.

### RELATED ART DOCUMENTS

### Patent Documents

Patent Document 1: Japanese Unexamined Patent Application 2004-346248

Patent Document 2: Japanese Unexamined Patent Application 2008-214625

Patent Document 3: International Patent Publication WO2010/013847

### SUMMARY OF THE INVENTION

### Problem to be Solved by the Invention

An objective of the present invention is to provide a multi-component sponge forming silicone rubber composition in which each liquid has excellent storage stability prior to mixing and which forms a silicone rubber sponge having fine and uniform open cells by mixing the liquids together.

### Means for Solving the Problem

A multi-component sponge forming silicone rubber composition of the present invention comprises a liquid I, a liquid II, and a liquid III, the liquids being mixed to form a composition containing:
(A) 100 parts by mass of an organopolysiloxane having at least two alkenyl groups per molecule;
(B) an organopolysiloxane having at least two silicon atom-bonded hydrogen atoms per molecule {in an amount such that the silicon atom-bonded hydrogen atoms in this component are 0.4 to 20 mols with respect to 1 mol of the alkenyl groups in component (A)};
(C) 20 to 1,000 parts by mass of water;
(D) 0.01 to 15 parts by mass of a thickener with respect to 100 parts by mass of component (C);
(E) 0.1 to 15 parts by mass of a surfactant;
(F) 1 to 20 parts by mass of silica fine powder;
(G) 0.1 to 10 parts by mass of an organosiloxane oligomer having a silicon atom-bonded hydroxyl group; and
(H) a hydrosilylation reaction catalyst in an amount sufficient to crosslink the present composition, wherein
the liquid I contains the aforementioned component (A) and the aforementioned component (H) but does not contain the aforementioned component (B),
the liquid II contains the aforementioned component (B) but does not contain the aforementioned component (H),
the liquid III contains the aforementioned component (C) and the aforementioned component (D), but does not simultaneously contain the aforementioned component (B) and the aforementioned component (H), and
at least one of the liquids I and II, which contains both the aforementioned component (E) and the aforementioned component (F), further contains the aforementioned component (G).

Component (A) is preferably an organopolysiloxane including (A-1) 10 to 90 mass % of a diorganopolysiloxane having an average of two alkenyl groups at molecular chain ends and no alkenyl groups on molecular side chains, and (A-2) 10 to 90 mass % of a diorganopolysiloxane having at least two alkenyl groups on a molecular side chain.

Component (D) is preferably at least one type of thickener selected from the group consisting of inorganic thickeners, cellulose fibers, water-soluble polymers, water-absorbing polymers, hydrophilic composites including the inorganic thickener and the water-soluble polymer, and hydrophilic composites including the inorganic thickener and the water-absorbing polymer.

Component (E) is preferably a surfactant including (E-1) a nonionic surfactant having an HLB value of 3 or more, and (E-2) a nonionic surfactant having an HLB value of less than 3 {with the proviso that the mass ratio of component (E-1) to component (E-2) is at least 1.}.

Component (G) is preferably an organosiloxane oligomer in which the amount of silicon atom-bonded hydroxyl groups is 1 to 10 mass %.

### Effect of the Invention

The multi-component sponge forming silicone rubber composition of the present invention is characterized by the excellent storage stability of each liquid prior to mixing, and by mixing the liquids together, a silicone rubber sponge having fine and uniform open cells is formed.

### DESCRIPTION OF THE PREFERRED EMBODIMENTS

### Definitions of Terms

The term “viscosity” as used in the present specification refers to a value (unit: mPa·s or Pa·s) at 25° C. measured using a B-type rotational viscometer in accordance with JIS K 7117-1:1999 “Plastics—Resins in the liquid state or as emulsions or dispersions—Determination of apparent viscosity by the Brookfield Test method”. Furthermore, the “kinematic viscosity” refers to a value (unit: mm²/s) at 25° C. measured by an Ubbelohde viscometer in accordance with JIS Z8803.

A multi-component sponge forming silicone rubber composition of the present invention will be described in detail.

The present composition includes the liquid I, the liquid II, and the liquid III, and each liquid is mixed to form a composition containing the aforementioned components (A) to (H).

Component (A) is an organopolysiloxane serving as a main component of the present composition and having at least two alkenyl groups per molecule. Examples of alkenyl groups in component (A) include alkenyl groups with 2 to 12 carbon atoms, such as vinyl groups, allyl groups, isopropenyl groups, butenyl groups, isobutenyl groups, pentenyl groups, hexenyl groups, heptenyl groups, octenyl groups, pentenyl groups, nonenyl groups, decenyl groups, dodecenyl groups, and the like, with vinyl groups being preferred. While the bonding position of the alkenyl group is not limited, the alkenyl group may be bonded to a silicon atom at a molecular chain end and/or a silicon atom in a molecular chain. Furthermore, examples of silicon atom-bonded organic groups other than the alkenyl group in component (A) include: methyl groups, ethyl groups, propyl groups, butyl groups, pentyl groups, hexyl groups, heptyl groups, octyl groups, nonyl groups, decyl groups, undecyl groups, dodecyl groups, and other alkyl groups with 1 to 12 carbon atoms; cyclopentyl groups, cyclohexyl groups, cycloheptyl groups, cyclooctyl groups, and other cycloalkyl groups with 5 to 12 carbon atoms; phenyl groups, tolyl groups, xylyl groups, naphthyl groups, and other aryl groups with 6 to 12 carbon atoms; benzyl groups, phenethyl groups, and other aralkyl groups with 7 to 12 carbon atoms; and groups obtained by substituting some or all hydrogen atoms of these groups with a halogen atom such as fluorine, chlorine, or the like. Methyl groups and phenyl groups are preferred.

The molecular structure of component (A) is not limited. Examples thereof include a linear structure, a partially branched linear structure, a branched structure, a cyclic structure, and a resinous structure, with a linear structure or a partially branched linear structure being preferred. Component (A) may be a mixture of two or more organopolysiloxanes having these molecular structures.

Examples of such components (A) include a dimethylpolysiloxane blocked with dimethylvinylsiloxy groups at both molecular chain ends, dimethylpolysiloxane blocked with diphenylvinylsiloxy groups at both molecular chain ends, dimethylsiloxane-methylphenylsiloxane copolymer blocked with dimethylvinylsiloxy groups at both molecular chain ends, dimethylsiloxane-diphenylsiloxane copolymer blocked with dimethylvinylsiloxy groups at both molecular chain ends, dimethylsiloxane-methylphenylsiloxane copolymer blocked with diphenylvinylsiloxy groups at both molecular chain ends, dimethylsiloxane-methylvinylsiloxane copolymer blocked with dimethylvinylsiloxy groups at both molecular chain dimethylsiloxane-methylphenylsiloxane-methylvinylsiloxane copolymer blocked with dimethylvinylsiloxy groups at both molecular chain ends, dimethylsiloxane-diphenylsiloxane-methylvinylsiloxane copolymer blocked with dimethylvinylsiloxy groups at both molecular chain ends, methylvinylpolysiloxane blocked with trimethylsiloxy groups at both molecular chain ends, methylvinylsiloxane-methylphenylsiloxane copolymer blocked with trimethylsiloxy groups at both molecular chain ends, methylvinylsiloxane-diphenylsiloxane copolymer blocked with trimethylsiloxy groups at both molecular chain ends, dimethylsiloxane-methylvinylsiloxane copolymer blocked with trimethylsiloxy groups at both molecular chain ends, and mixtures of two or more of these organopolysiloxanes.

Furthermore, the viscosity of component (A) is not limited. However, the viscosity at 25° C. is preferably 50 mPa·s or more or 100m Pa·s or more, and 100,000 mPa·s or less. This is because, if the viscosity of component (A) is at the abovementioned lower limit or more and the abovementioned upper limit or less, a silicone rubber sponge having a stable emulsion of the obtained silicone rubber composition and having uniform cells tends to be obtained.

Such a component (A) is preferably a mixture of (A-1) a diorganopolysiloxane having an average of two alkenyl groups at molecular chain ends and no alkenyl groups on molecular side chains and (A-2) a diorganopolysiloxane having at least two alkenyl groups on a molecular side chain.

Component (A-1) is a diorganopolysiloxane having an average of two alkenyl groups at a molecular chain end and having no alkenyl group at a molecular side chain. Specific examples thereof include a dimethylpolysiloxane blocked with dimethylvinylsiloxy groups, a dimethylsiloxane-methylphenylsiloxane copolymer blocked with dimethylvinylsiloxy groups, and a branched dimethylpolysiloxane in which the main chain includes a repeated dimethylsiloxane unit, the main chain is partially branched, and molecular chain ends are blocked with dimethylvinylsiloxy groups, with a diorganopolysiloxane having a substantially linear main chain being preferable.

Component (A-2) is a diorganopolysiloxane having at least two alkenyl groups at a molecular side chain. Specific examples thereof include a methylvinylpolysiloxane blocked with trimethylsiloxy groups, dimethylsiloxane-methylvinylsiloxane copolymers blocked with trimethylsiloxy groups, methylvinylpolysiloxane blocked with dimethylvinylsiloxy groups, dimethylsiloxane-methylvinylsiloxane copolymers blocked with dimethylvinylsiloxy groups, dimethylsiloxane-methylvinylsiloxane-methylphenylsiloxane copolymers blocked with trimethylsiloxy groups, and a branched dimethylsiloxane-methylvinylsiloxane copolymer in which the main chain includes a repeated dimethylsiloxane unit and methylvinylsiloxane unit, the main chain is partially branched, and molecular chain ends are blocked with trimethylsiloxy groups. A diorganopolysiloxane having a substantially linear main chain is preferable.

The blending ratio of component (A-1) and component (A-2) is not limited, but component (A) preferably includes 10 to 90 mass % of component (A-1) and 10 to 90 mass % of component (A-2) because the shrinkage rate of the obtained silicone rubber sponge is improved thereby.

Component (B) is a crosslinking agent for the present composition and is an organopolysiloxane having at least two silicon atom-bonded hydrogen atoms per molecule. The silicon atom-bonded hydrogen atom in component (B) may be bonded to a silicon atom at a molecular chain end and/or silicon atom in a molecular chain. The molecular structure of component (B) is not limited. Examples thereof include a linear structure, a partially branched linear structure, a branched structure, a cyclic structure, and a dendritic structure, with a linear structure or a partially branched linear structure being preferred. Component (B) is preferably a linear organopolysiloxane.

Examples of such components (B) include a dimethylpolysiloxane blocked with dimethylhydrogensiloxy groups at both molecular chain ends, a dimethylsiloxane-methylphenylsiloxane copolymer blocked with dimethylhydrogensiloxy groups at both molecular chain ends, a dimethylsiloxane-methylhydrogensiloxane copolymer blocked with dimethylhydrogensiloxy groups at both molecular chain ends, a dimethylsiloxane-methylhydrogensiloxane copolymer blocked with trimethylsiloxy groups at both molecular chain ends, an organopolysiloxane including H(CH₃)₂SiO_{1/2} units and SiO_{4/2} units, and an organopolysiloxane including H(CH₃)₂SiO_{1/2} units, (CH₃)₃SiO_{1/2} units, and SiO_{4/2} units.

The viscosity of component (B) is not limited. However, the kinematic viscosity at 25° C. is preferably 1 mm²/s or more and 1,000 mm²/s or less. Alternatively, the viscosity at 25° C. is preferably 5 mPa·s or more and 1,000 mPa·s or less. This is because, if the viscosity of component (B) is at the abovementioned lower limit or more and the abovementioned upper limit or less, a silicone rubber sponge having a stable emulsion of the obtained silicone rubber composition and having uniform cells tends to be obtained.

The amount of component (B) is such that silicon atom-bonded hydrogen atoms in the this component are within the range of 0.4 to 20 mols with respect to 1 mol of alkenyl groups in component (A). The lower limit thereof is preferably an amount of 1.0 mol, an amount of 1.5 mols, or an amount of 1.8 mols, and the upper limit thereof is an amount of 10 mols, or an amount of 5 mols. This is because, if the amount of component (B) is within the abovementioned range, the compression set of the obtained silicone rubber sponge is improved.

Water in component (C) is a component that is removed from silicone rubber after crosslinking the present composition, so as to make the silicone rubber porous. The amount of component (C) is within the range of 20 to 1,000 parts by mass with respect to 100 parts by mass of component (A). The lower limit thereof is preferably 20 parts by mass, 30 parts by mass, 40 parts by mass, or 50 parts by mass, and the upper limit is preferably 800 parts by mass, 650 parts by mass, or 500 parts by mass. This is because, if the amount of component (C) is at the lower limit or more of the abovementioned range, the obtained silicone rubber sponge is more likely to be porous and have uniform cells. On the other hand, if the amount is at the upper limit or less of the abovementioned range, a silicone rubber sponge is more likely to be obtained.

While not limited thereto, the water used in component (C) can be tap water, well water, ion-exchanged water, distilled water, and the like. In particular, from the perspective of stabilizing the dispersion in component (A), component (C) is preferably ion-exchanged water.

The thickener in component (D) is a component for thickening the water in component (C), facilitating the dispersion of component (C) in component (A), and stabilizing the dispersion state of component (C) in component (A) to obtain a uniform and porous silicone rubber. Such a component (D) is preferably at least one selected from the group consisting of inorganic thickeners, cellulose fibers, water-soluble polymers, water-absorbing polymers, hydrophilic composites including the inorganic thickener and the water-soluble polymer, and hydrophilic composites including the inorganic thickener and the water-absorbing polymer.

The inorganic thickener in component (D) is a natural or synthetic inorganic thickener, and examples thereof include bentonite and other natural or synthetic smectite clays, in which a clay mineral (such as bentonite (montmorillonite), hectorite, saponite, sauconite, beidellite, nontronite, or the like) serves as a main component. Such a smectite clay, for example, is available as SUMECTON as a hydrothermal synthetic product (registered trademark of KUNIMINE INDUSTRIES CO., LTD.), LUCENTITE (registered trademark of Co-op Chemical Co., Ltd.), KUNIPIA as a natural refined product (registered trademark of KUNIMINE INDUSTRIES CO., LTD.), BEN-GEL (registered trademark of HOJUN CO., LTD.), BENTONE (registered trademark of Elementis PLC), and VEEGUM (registered trademark of R.T. Vanderbilt Company, Inc.). A rise in viscosity upon dispersion in water is significant and the amount of component (E) can be reduced. Therefore, the inorganic thickener is preferably bentonite (montmorillonite), hectorite, or saponite. From the perspective of maintaining the heat resistance of the silicone rubber sponge, the pH of these smectite clays is preferably within the pH range of 5.0 to 9.0. Furthermore, a hydrophilic composite including such smectite clays and water-soluble polymer or water-absorbing polymer, such as polyacrylic acid or the like, may be used.

The cellulose fibers in component (D) are formed into nanofibers by subjecting natural or synthetic cellulose fibers to chemical treatment or physical treatment. From the perspective of dispersibility, thickening properties, and the like, the number average fiber diameter of such cellulose fibers is preferably within the range of 2 to 150 nm, within the range of 2 to 100 nm, or within the range of 2 to 10 nm. This is because, if the number average fiber diameter is within the abovementioned range, the fibers are less likely to settle when dispersed in water and can maintain fluidity and thicken.

The cellulose fibers in component (D) are available as an aqueous dispersion of cellulose nanofibers produced by DKS Co. Ltd. (trade name: Rheocrysta C-2SP).

Examples of water-soluble polymers in component (D) include alginic acid, sodium alginate, sodium salt of carboxylate, sodium salt of carboxy cellulose, methyl cellulose, cellulose ether, hydroxyethyl cellulose, modified starch, polyvinyl alcohol, polyacrylate, or a sodium salt of polyacrylate.

Furthermore, examples of water-absorbing polymers in component (D) include polypolyacrylate crosslinked bodies and polyoxyalkylene-based water-absorbing resins.

The amount of component (D) is within the range of 0.01 to 15 parts by mass with respect to 100 parts by mass of component (C). The lower limit thereof is preferably 0.05 parts by mass or 0.1 parts by mass, and the upper limit thereof is preferably 10 parts by mass or 5 parts by mass. This is because, if the amount of component (D) is at the lower limit or more of the abovementioned range, component (C) can be sufficiently thickened. On the other hand, if the amount is at the upper limit or less of the abovementioned range, emulsification of the silicone rubber composition can be stabilized.

Component (E) is a surfactant for uniformly emulsifying water in the silicone rubber composition to obtain a uniform and porous silicone rubber. Examples of such components (E) include anionic, cationic, amphoteric ionic, and nonionic surfactants. Specific examples thereof include: nonionic surfactants such as glycerin fatty acid esters, polyglycerin fatty acid esters, sorbitan fatty acid esters, sucrose fatty acid esters, polyethylene glycol fatty acid esters, polypropylene glycol fatty acid esters, polyoxyethylene glycerin fatty acid esters, polyoxyethylene sorbitan fatty acid esters, polyoxyethylene-polyoxypropylene block copolymers, polyoxyethylene alkylether, polyoxyethylene alkylphenylether, polyoxyethylene fatty acid amide, and the like; nonionic surfactants including polyorganosiloxanes such as polysiloxane-polyoxyethylene graft copolymers and the like; cationic surfactants such as aliphatic amine salts, quaternary ammonium salts, alkylpyridinium salts, and the like; anionic surfactants such as higher fatty acid salts, higher alcohol sulfuric ester salts, alkylbenzene sulfonate, alkylnaphthalene sulfonate, polyethylene glycol sulfuric ester salts, and the like; and carboxy betaine type or glycine type amphoteric ionic surfactants. In particular, nonionic surfactants are preferable because a hydrosilylation reaction of the present composition has little effect on crosslinking.

These surfactants may be used alone or two or more types thereof may be used in combination. The HLB value of an emulsifier (note that it is the weight average HLB value thereof if two or more surfactants are used in combination) is preferably 1 or more and 10 or less, 1.5 or more and less than 6, or 3.5 or more and less than 6.

As component (E), a surfactant is preferably used, which includes: (E-1) a nonionic surfactant having an HLB value of 3 or more; and (E-2) a nonionic surfactant having an HLB value of less than 3. The mass ratio of component (E-1) to component (E-2) is at least 1, preferably at least 5, at least 8, at least 10, or at least 15. Furthermore, the mass ratio of component (E-1) to component (E-2) is preferably at most 100 or less, more preferably at most 80, at most 70, at most 60, or at most 50. This is because, if the mass ratio is at the abovementioned lower limit or more, a low density sponge having a uniform and fine open cell structure can be formed. On the other hand, if the mass ratio is at the abovementioned upper limit or less, components (C) and (D) can be stably dispersed in component (A), such that a silicone rubber sponge having a uniform and fine open cell structure can be formed.

The amount of component (E) is within the range of 0.1 to 15 parts by mass with respect to 100 parts by mass of component (A). The lower limit thereof is preferably 0.2 parts by mass, and the upper limit thereof is preferably 10 parts by mass. This is because, if the amount of component (E) is at the lower limit or more of the abovementioned range, component (C) can be uniformly dispersed in component (A). On the other hand, if the amount is at the lower limit or less of the abovementioned range, the mechanical properties and electrical properties of the obtained silicone rubber sponge are not affected.

Component (F) is a silica fine powder that is added to improve the mechanical strength of the obtained silicone rubber sponge. Examples of component (F) include fumed silica and precipitated silica. Furthermore, these silica fine powders may be surface-treated with a chain polyorganosiloxane, a cyclic polyorganosiloxane, hexamethyldisilazane, various organosilanes, or the like. Furthermore, component (F) preferably has a specific surface area of 50 to 500 m²/g or 80 to 450 m²/g using a BET adsorption method.

The amount of component (F) is within the range of 1 to 20 parts by mass with respect to 100 parts by mass of component (A). This is because, if the amount of component (F) is at the lower limit or more of the abovementioned range, the mechanical strength of the obtained silicone rubber sponge can be improved. On the other hand, if the amount is at the upper limit or less of the abovementioned range, the uniformity and fineness of the cells in the obtained silicone rubber sponge is not impaired.

Component (G) is an organosiloxane oligomer having a silicon atom-bonded hydroxyl group that is added to improve the storage stability of each component in a multi-component sponge forming silicone rubber composition. Examples of the silicon atom-bonded organic groups in component (G) include: methyl groups, ethyl groups, propyl groups, butyl groups, pentyl groups, hexyl groups, heptyl groups, octyl groups, nonyl groups, decyl groups, undecyl groups, dodecyl groups, and other alkyl groups with 1 to 12 carbon atoms; cyclopentyl groups, cyclohexyl groups, cycloheptyl groups, cyclooctyl groups, and other cycloalkyl groups with 5 to 12 carbon atoms; vinyl groups, allyl groups, isopropenyl groups, butenyl groups, isobutenyl groups, pentenyl groups, hexenyl groups, heptenyl groups, octenyl groups, pentenyl groups, nonenyl groups, decenyl groups, dodecenyl groups, and other alkenyl groups with 2 to 12 carbon atoms; phenyl groups, tolyl groups, xylyl groups, naphthyl groups, and other aryl groups with 6 to 12 carbon atoms; benzyl groups, phenethyl groups, and other aralkyl groups with 7 to 12 carbon atoms; and groups obtained by substituting some or all hydrogen atoms of these groups with a halogen atom such as fluorine, chlorine, or the like. Methyl groups, vinyl groups and phenyl groups are preferred. The amount of the silicon atom-bonded hydroxyl group (i.e., silanol groups) in component (G) is not particularly limited but is preferably 1 to 10 mass %. Examples of such a component (G) include a dimethylsiloxane-methylvinylsiloxane copolymer oligomer blocked with dimethylhydroxysiloxy groups at both molecular chain ends, a methylvinylsiloxane oligomer blocked with dimethylhydroxysiloxy groups at both molecular chain ends, a dimethylsiloxane oligomer blocked with dimethylhydroxysiloxy groups at both molecular chain ends, and a methylphenylsiloxane oligomer blocked with methylphenylhydroxysiloxy groups at both molecular chain ends.

The amount of component (G) is within the range of 0.1 to 10 parts by mass, and preferably within the range of 0.1 to 5 parts by mass, or 0.1 to 3 parts by mass, with respect to 100 parts by mass of component (A). This is because, if the amount of component (G) is at the lower limit or more of the abovementioned range, the storage stability of each component when formed into a multi-component sponge forming silicone rubber composition is improved. On the other hand, if the amount is at the upper limit or less of the abovementioned range, the mechanical properties of the obtained silicone rubber sponge are not affected.

Component (H) is a hydrosilylation reaction catalyst for accelerating the hydrosilylation reaction of the present composition, and examples thereof include platinum-based catalysts, palladium-based catalysts, and rhodium-based catalysts, with platinum-based catalysts being preferred. Examples of such component (H) include: chloroplatinic acid; alcohol-modified chloroplatinic acid; coordination compounds of chloroplatinic acid with olefins, vinylsiloxane, or acetylene compounds; coordination compounds of platinum with olefins, vinylsiloxanes, or acetylene compounds; and powdered platinum-based catalysts and other platinum-based catalysts in which the above are dispersed in a thermoplastic resin, as well as tetrakis(triphenylphosphine)palladium and other palladium-based catalysts and chlorotris(triphenylphosphine)rhodium and other rhodium-based catalysts.

The amount of component (H) is an amount sufficient to crosslink the present composition, and is specifically preferably an amount in which a catalytic metal in component (H), in mass units, is within the range of 0.01 to 500 ppm or within the range of 0.1 to 100 ppm, with respect to the total amount of components (A) and (B).

The present composition may further contain a hydrosilylation reaction inhibitor in order to adjust the crosslinking rate and working pot life of the present composition. Examples of the hydrosilylation reaction inhibitor include 3-methyl-1-butyn-3-ol, 3,5-dimethyl-1-hexyn-3-ol, 3-phenyl-1-butyn-3-ol, 1-ethynyl-1-cyclohexanol, and other alkyne alcohols; 3-methyl-3-penten-1-yne, 3,5-dimethyl-3-hexen-1-yne, and other enyne compounds; tetramethyltetravinylcyclotetrasiloxane and tetramethyltetrahexenylcyclotetrasiloxane; and methyl-tris(1,1-dimethyl-2-butynoxy)silane, vinyl-tris(1, 1-dimethyl-2-butynoxy)silane, and other alkyne-containing silanes.

The amount of the hydrosilylation reaction inhibitor is not limited and is appropriately selected in accordance with a method for using or molding the present composition. However, the amount is preferably within the range of 0.001 parts by mass to 5 parts by mass with respect to 100 parts by mass of component (A) because the crosslinking rate and working pot life of the present composition can be sufficiently adjusted.

The present composition may contain a conductive filler in order to impart electric conductivity to the obtained silicone rubber sponge. Examples of conductive fillers include: carbon-based conductive agents such as carbon black, carbon fibers, carbon nanotubes, graphite, and the like; metal powders such as gold, silver, nickel, and the like; conductive zinc oxide, conductive titanium oxide, and conductive aluminum oxide; conductive fillers obtained by subjecting filler surfaces to a conductive coating treatment, such as subjecting various filler surfaces to a metal plating treatment, and the like; and mixtures of two or more thereof. The conductive filler is preferably carbon black because favorable conductivity can be obtained by the addition of a small amount. Specific examples thereof include acetylene black, conductive furnace black (CF), superconductive furnace black (SCF), extraconductive furnace black (XCF), conductive channel black (CC), and furnace black or channel black heat-treated at a high temperature of approximately 1500° C. The amount of the conductive filler is not limited but is preferably 100 parts by mass or less or 70 parts by mass or less with respect to 100 parts by mass of component (A) because a favorable sponge can be obtained.

So long as the objective of the present invention is not impaired, the present composition may contain, as another arbitrary component: fumed titanium oxide and other reinforcing fillers other than silica; quartz powder, diatomaceous earth, aluminosilicate, iron oxide, zinc oxide, calcium carbonate, aluminum oxide, cerium oxide, mica, clay, zinc carbonate, and other non-reinforcing fillers; fillers obtained by surface-treating these fillers with an organosilane, polyorganosiloxane, or other organosilicon compound; and, in addition, an antiseptic agent, rust-preventing agent, pigment, heat-resistant agent, flame retardant, internal mold release agent, plasticizer, acid acceptor, or nonfunctional silicone oil.

The present composition is characterized by including the liquid I, the liquid II, and the liquid III, and each liquid is mixed to form a composition containing the aforementioned components (A) to (H).
Moreover, the liquid I contains the aforementioned component (A) and the aforementioned component (H) but does not contain the aforementioned component (B),
the liquid II contains the aforementioned component (B) but does not contain the aforementioned component (H),
the liquid III contains the aforementioned component (C) and the aforementioned component (D), but does not simultaneously contain the aforementioned component (B) and the aforementioned component (H), and
at least one of the liquids I and II, which contains both the aforementioned component (E) and the aforementioned component (F), further contains the aforementioned component (G).
This is because, in at least one of the liquids containing both component (E) and component (F), a silanol group on the surface of component (F) is promoted to undergo pseudo-crosslinking by a hydrophilic group in component (E), causing the liquid to thicken over time. However, the present invention has been achieved by discovering that this thickening can be suppressed by further adding component (G).

In other words, when the liquid I contains component (A) and component (H), and further contains both component (E) and component (F), the liquid I must further contain component (G). On the other hand, when the liquid II contains component (B), and further contains both component (E) and component (F), the liquid II must further contain component (G). Note that although the liquid III contains components (C) and (D), there are few aspects in which the liquid III further contains both components (E) and (F).

Note that when a metal oxide, such as cerium oxide, iron oxide, or titanium oxide, is added in order to improve heat resistance, the metal compound is preferably not simultaneously included with component (E) in order to avoid impairing the chemical stability of component (E).

The method for forming a silicone rubber sponge using the present composition is not limited. For example, the present composition is uniformly emulsified and then injected into a cavity of a metal die and maintained under pressure at a temperature of less than 100° C., and preferably 50 to 90° C., to form a silicone rubber molded body in a water-containing state. The silicone rubber molded body in a water-containing state is then removed from the metal die and subjected to secondary vulcanization at 120 to 250° C., and more preferably 120 to 210° C., to remove water therefrom, thereby obtaining a silicone rubber sponge having fine and uniform cells. Furthermore, the present composition is ejected from a nozzle in a rod shape, for example, introduced into hot water at 80 to 100° C. and cured, after which a cured product can be dried with hot air to prepare a string-shaped silicone rubber sponge. Furthermore, the present composition can be coated on a peelable base material, such as a resin film or the like, for example, heated and cured to 50 to 120° C., and dried with hot air to remove water or heated and cured while removing water, with the peelable base material then removed so as to form a silicone rubber sponge sheet. Alternatively, the present composition can be coated on a synthetic fiber fabric and a glass cloth, for example, heated and cured to 50 to 120° C., and dried with hot air to remove water or heated and cured while removing water so as to form a silicone rubber sponge coating fabric.

The silicone rubber sponge has excellent water absorption and water retentivity and the volume thereof tends not to expand (even if water is absorbed), in other words, the sponge tends not to swell. Therefore, the silicone rubber sponge is suitable as a cooling sheet material and a water-absorbing pad material. Furthermore, the silicone rubber sponge is also suitable as an absorbent material or retaining material for aqueous solutions of inorganic salts, aqueous solutions of organic compounds, and hydrophilic organic compounds, in addition to water. The thickness of the silicone rubber sponge layer is not limited but is preferably within the range of 0.05 to 80 mm or within the range of 0.1 to 50 mm because rubber elasticity is effectively utilized.

### EXAMPLES

A multi-component sponge forming silicone rubber composition of the present invention will be described in further detail using examples. Note that in the examples, the viscosity is the value at 25° C.

### Changes in Viscosity of Liquid I and Liquid II

The liquids I and II were stored at 25° C., and the viscosities thereof at an initial stage and after one month, two months, and three months were measured using a B-type rotational viscometer in accordance with JIS K 7117-1:1999 “Plastics—Resins in the liquid state or as emulsions or dispersions—Determination of apparent viscosity by the Brookfield Test method”.

### Density

The density of the silicone rubber sponge was measured in accordance with JIS K 6249:2003 “Testing methods for uncured and cured silicone rubber”.

### Asker C Hardness

The Asker C hardness of the silicone rubber sponge was measured in accordance with a test method using a type C hardness tester specified in JIS K 7312:1996 “Physical testing methods for molded products of thermosetting polyurethane elastomers”. Note that for the measurement, two silicone rubber sponge test pieces having a thickness of 6 mm were laminated and used.

### Tensile Strength and Elongation

The tensile strength and elongation at break of the silicone rubber sponge were measured in accordance with a method specified in JIS K 6249:2003 “Testing methods for uncured and cured silicone rubber”.

### Tear Strength

The tear strength of the silicone rubber sponge was measured in accordance with a method specified in JIS K 6249:2003 “Testing methods for uncured and cured silicone rubber”. Note that measurements were performed using a silicone rubber sponge test piece having a thickness of 6 mm.

### Rebound Resilience

The rebound resilience of the silicone rubber sponge was measured in accordance with the method specified in JIS K 6255:1996 “Rubber, vulcanized or thermoplastic-Determination of rebound resilience”.

### Compression Set

The compression set of the silicone rubber sponge was measured in accordance with a method specified in JIS K 6249:2003 “Testing methods for uncured and cured silicone rubber”. Note that the compression set is a value after treatment at 180° C. and 25% compression for 22 hours.

### Examples 1 to 3 and Comparative Example 1

The following components were introduced into a homomixer (manufactured by Tokushu Kika Kogyo Co., Ltd.) in the amounts shown in Table 1 and mixed at 25° C. until uniform, to prepare liquids I and II. The viscosity change at 25° C. of each of the liquids I and II was measured. Furthermore, the liquids I and II were mixed with a separately prepared liquid III to prepare a sponge forming silicone rubber composition. Note that in the silicone rubber composition, the molar ratio of silicon atom-bonded hydrogen atoms in the component corresponding to component (B) to the total of 1 mol of vinyl groups in the component corresponding to component (A) was 3.

The obtained sponge forming silicone rubber composition was crosslinked and cured under conditions of 90° C./10 minutes using a compression molding machine to prepare a silicone rubber test piece in a water-containing state. Subsequently, the test piece was left to stand in an open system at 200° C. for four hours to remove water in the test piece and obtain a silicone rubber sponge test piece. The silicone rubber sponge test piece was used to measure the density, Asker C hardness, tensile strength, elongation at break, tear strength, rebound resilience and compression set. The results are shown in Table 2.

The following component was used as component (A-1).
Component (a1): a dimethylpolysiloxane blocked with dimethylvinylsiloxy groups at both molecular chain ends having a viscosity of 10 Pa·s (amount of vinyl groups: 0.14 mass %)

The following components were used as component (A-2).
Component (a2): a dimethylmethylvinylpolysiloxane blocked with trimethylsiloxy groups at both molecular chain ends having a viscosity of 38 Pas (amount of vinyl groups=0.50 mass %).
Component (a3): a dimethylsiloxane/methylvinylsiloxane copolymer blocked with dimethylvinylsiloxy groups at both molecular chain ends having a viscosity of 350 mPa·s (amount of vinyl groups: approximately 1.17 mass %).

The following component was used as component (B).
Component (b1): a dimethylsiloxane-methylhydrogensiloxane copolymer blocked with trimethylsiloxy groups at both molecular chain ends having a viscosity of 52 mPa·s (amount of silicon atom-bonded hydrogen atoms: approximately 0.70 mass %)

As component (C), (c1) ion-exchanged water was used, and as component (D), (d1) smectite clay (organic polymer composite refined bentonite produced by HOJUN CO., LTD.; pH of 6.5) was used. 0.85 parts by mass of the smectite clay and 99.15 parts by mass of the ion-exchanged water were introduced in advance into a homomixer and mixed at room temperature until uniform, to prepare liquid III. Note that the same liquid III was used in Examples 1 to 3 and Comparative Example 1.

The following components were used as component (E).
Component (e1): a nonionic surfactant with an HLB of 4.3 (sorbitan fatty acid ester, RHEODOL SP-010V produced by Kao Corporation).
Component (e-2): a nonionic surfactant with an HLB of 1.8 (sorbitan fatty acid ester, RHEODOL SP-O30V produced by Kao Corporation).

As component (F), the following silica masterbatch was used.
Component (f1): a silica masterbatch prepared by adding 100 parts by mass of a dimethylpolysiloxane blocked with dimethylvinylsiloxy groups at both molecular chain ends and having a viscosity of 40 Pa·s (amount of vinyl groups=0.09 mass %), 50 parts by mass of fumed silica with a BET specific surface area of 380 m²/g, 10 parts by mass of hexamethyldisilazane, and 2 parts by mass of water to a Ross mixer, mixing at room temperature until uniform, and then heat-treating the mixture at 200° C. under reduced pressure for 2 hours.

The following components were used as component (G).
Component (g1): a dimethylsiloxane-methylvinylsiloxane copolymer blocked with dimethylhydroxysiloxy groups at both molecular chain ends and having a viscosity of 19 mPa·s (amount of silicon atom-bonded hydroxyl groups=8.2 mass %)
Component (g2): a dimethylsiloxane oligomer blocked with dimethylhydroxysiloxy groups at both molecular chain ends and having a viscosity of 21 mPa·s (amount of silicon atom-bonded hydroxyl groups=8.5 mass %)
Component (g3): a methylphenylsiloxane oligomer blocked with methylphenylhydroxysiloxy groups at both molecular chain ends and having a viscosity of 440 mPa·s (amount of silicon atom-bonded hydroxyl groups=6.5 mass %)

The following component was used as component (H).
Component (h1): a microparticulate platinum catalyst having an average particle size of 1 μm and made of a thermoplastic silicone resin with a softening point of 65° C., containing approximately 0.4 mass % of platinum metal in the form of a 1,3-divinyltetramethyldisiloxane complex

The following pigment paste was used as another component.
Component (i1): a mixture of 60 parts by mass of dimethylpolysiloxane blocked with dimethylvinylsiloxy groups at both molecular chain ends and having a viscosity of 10 Pa·s (amount of vinyl groups=0.14 mass %), and 40 parts by mass of iron oxide (trade name: Bayferrox produced by Bayer AG) having an average particle size of 0.17 μm

TABLE 1

| | | | Comparative | | | | | | | | | | Common |
|---|---|---|---|---|---|---|---|---|---|---|---|---|---|
| | | | Example 1 | | Example 1 | | Example 2 | | Example 3 | | Example 4 | | Liquid |
| | | | Liquid I | Liquid II | Liquid I | Liquid II | Liquid I | Liquid II | Liquid I | Liquid II | Liquid I | Liquid II | III |
| Composition | (A) | (a1) | 0 | 15.5 | 0 | 15.5 | 0 | 15.5 | 0 | 15.5 | 0 | 15.5 | 0 |
| of multi- | | (a2) | 21.8 | 6.5 | 24.6 | 3.7 | 24.6 | 3.7 | 24.6 | 3.7 | 24.6 | 3.7 | 0 |
| component | | (a3) | 45.0 | 28.0 | 43.0 | 30.0 | 43.0 | 30.0 | 43.0 | 30.0 | 43.0 | 30.0 | 0 |
| sponge | (B) | (b1) | 0 | 16.9 | 0 | 16.9 | 0 | 16.9 | 0 | 16.9 | 0 | 16.9 | 0 |
| forming | (C) | (c1) | 0 | 0 | 0 | 0 | 0 | 0 | 0 | 0 | 0 | 0 | 99.15 |
| silicone | (D) | (d1) | 0 | 0 | 0 | 0 | 0 | 0 | 0 | 0 | 0 | 0 | 0.85 |
| rubber | (E) | (e1) | 0 | 2.0 | 0 | 2.0 | 0 | 2.0 | 0 | 2.0 | 0 | 2.0 | 0 |
| composition | | (e2) | 0 | 0.1 | 0 | 0.1 | 0 | 0.1 | 0 | 0.1 | 0 | 0.1 | 0 |
| (parts by | (F) | (f1) | 21.0 | 31.0 | 21.0 | 31.0 | 21.0 | 31.0 | 21.0 | 31.0 | 21.0 | 31.0 | 0 |
| mass) | (G) | (g1) | 0.8 | 0 | 0 | 0.8 | 0 | 0 | 0 | 0 | 0 | 0 | 0 |
| | | (g2) | 0 | 0 | 0 | 0 | 0 | 0.8 | 0 | 0.4 | 0 | 0 | 0 |
| | | (g3) | 0 | 0 | 0 | 0 | 0 | 0 | 0 | 0 | 0 | 0.8 | 0 |
| | (H) | (h1) | 1.2 | 0 | 1.2 | 0 | 1.2 | 0 | 1.2 | 0 | 1.2 | 0 | 0 |
| | Other | (i1) | 10.0 | 0 | 10.0 | 0 | 10.0 | 0 | 10.0 | 0 | 10.0 | 0 | 0 |

TABLE 2

| | | Comparative | | | | | | | | | |
|---|---|---|---|---|---|---|---|---|---|---|---|
| | | Example 1 | | Example 1 | | Example 2 | | Example 3 | | Example 4 | |
| | | Liquid | Liquid | Liquid | Liquid | Liquid | Liquid | Liquid | Liquid | Liquid | Liquid |
| | | I | II | I | II | I | II | I | II | I | II |
| Viscosity | Initial | 10.0 | 12.3 | 10.4 | 10.6 | 10.4 | 10.2 | 10.4 | 10.9 | 10.4 | 11.6 |
| (Pa · s) | After 1 month | 11.3 | 15.1 | 12.1 | 12.3 | 12.1 | 12.4 | 12.1 | 12.9 | 12.1 | 13.4 |
| | After 2 months | 10.4 | 16.3 | 11.0 | 11.8 | 11.0 | 11.5 | 11.0 | 12.1 | 11.0 | 13.0 |
| | After 3 months | 10.5 | 20.1 | 11.0 | 12.0 | 11.0 | 12.1 | 11.0 | 12.8 | 11.0 | 14.2 |
| Properties | Density (g/cm³) | 0.54 | | 0.55 | | 0.55 | | 0.55 | | 0.55 | |
| of | Asker C | 48 | | 48 | | 45 | | 45 | | 42 | |
| silicone | hardness | | | | | | | | | | |
| rubber | Tensile strength | 1.1 | | 1.1 | | 1.0 | | 1.0 | | 0.8 | |
| sponge | (Mpa) | | | | | | | | | | |
| | Elongation at | 59 | | 57 | | 57 | | 56 | | 47 | |
| | break (%) | | | | | | | | | | |
| | Tear strength | 1.2 | | 1.3 | | 1.5 | | 1.4 | | 1.3 | |
| | (N/mm) | | | | | | | | | | |
| | Rebound | 82 | | 82 | | 82 | | 82 | | 83 | |
| | resilience (%) | | | | | | | | | | |
| | Compression | 20 | | 25 | | 34 | | 34 | | 30 | |
| | set (%) | | | | | | | | | | |

### INDUSTRIAL APPLICABILITY

The multi-component sponge forming silicone rubber composition of the present invention has excellent storage stability for each liquid before mixing, and forms a silicone rubber sponge with fine and uniform open cells by mixing the liquids, making the composition suitable for use in forming a silicone rubber sponge used in harsh environments, such as heat-insulating materials, sound-absorbing materials, cushions, packings, gaskets, pads, and the like.

1. A multi-component sponge forming silicone rubber composition comprising a liquid I, a liquid II, and a liquid III, the liquids being mixed to form a composition containing:
(A) 100 parts by mass of an organopolysiloxane having at least two alkenyl groups per molecule;
(B) an organopolysiloxane having at least two silicon atom-bonded hydrogen atoms per molecule, in an amount such that the silicon atom-bonded hydrogen atoms in this component are 0.4 to 20 mols with respect to 1 mol of the alkenyl groups in component (A);
(C) 20 to 1,000 parts by mass of water;
(D) 0.01 to 15 parts by mass of a thickener with respect to 100 parts by mass of component (C);
(E) 0.1 to 15 parts by mass of a surfactant;
(F) 1 to 20 parts by mass of silica fine powder;
(G) 0.1 to 10 parts by mass of an organosiloxane oligomer having a silicon atom-bonded hydroxyl group; and
(H) a hydrosilylation reaction catalyst in an amount sufficient to crosslink the silicone rubber composition; wherein;
the liquid I contains components (A) and (H) but does not contain component (B),
the liquid II contains component (B) but does not contain component (H),
the liquid III contains components (C) and (D), but does not simultaneously contain components (B) and (H), and
at least one of the liquids I and II, which contains both components (E) and (F), further contains component (G).

2. The multi-component sponge forming silicone rubber composition according to claim 1, wherein component (A) is an organopolysiloxane including (A-1) 10 to 90 mass % of a diorganopolysiloxane having an average of two alkenyl groups at molecular chain ends and no alkenyl groups on molecular side chains, and (A-2) 10 to 90 mass % of a diorganopolysiloxane having at least two alkenyl groups on a molecular side chain.

3. The multi-component sponge forming silicone rubber composition according to claim 1, wherein component (D) is at least one type of thickener selected from the group consisting of inorganic thickeners, cellulose fibers, water-soluble polymers, water-absorbing polymers, hydrophilic composites including the inorganic thickener and the water-soluble polymer, and hydrophilic composites including the inorganic thickener and the water-absorbing polymer.

4. The multi-component sponge forming silicone rubber composition according to claim 1, wherein component (E) is a surfactant including (E-1) a nonionic surfactant having an HLB value of 3 or more, and (E-2) a nonionic surfactant having an HLB value of less than 3, with the proviso that the mass ratio of component (E-1) to component (E-2) is at least 1.

5. The multi-component sponge forming silicone rubber composition according to claim 1, wherein component (G) is an organosiloxane oligomer in which the amount of silicon atom-bonded hydroxyl groups is 1 to 10 mass %.

6. The multi-component sponge forming silicone rubber composition according to claim 2, wherein component (D) is at least one type of thickener selected from the group consisting of inorganic thickeners, cellulose fibers, water-soluble polymers, water-absorbing polymers, hydrophilic composites including the inorganic thickener and the water-soluble polymer, and hydrophilic composites including the inorganic thickener and the water-absorbing polymer.

7. The multi-component sponge forming silicone rubber composition according to claim 6, wherein component (E) is a surfactant including (E-1) a nonionic surfactant having an HLB value of 3 or more, and (E-2) a nonionic surfactant having an HLB value of less than 3, with the proviso that the mass ratio of component (E-1) to component (E-2) is at least 1.

8. The multi-component sponge forming silicone rubber composition according to claim 7, wherein component (G) is an organosiloxane oligomer in which the amount of silicon atom-bonded hydroxyl groups is 1 to 10 mass %.

9. The multi-component sponge forming silicone rubber composition according to claim 2, wherein component (E) is a surfactant including (E-1) a nonionic surfactant having an HLB value of 3 or more, and (E-2) a nonionic surfactant having an HLB value of less than 3, with the proviso that the mass ratio of component (E-1) to component (E-2) is at least 1.

10. The multi-component sponge forming silicone rubber composition according to claim 9, wherein component (G) is an organosiloxane oligomer in which the amount of silicon atom-bonded hydroxyl groups is 1 to 10 mass %.

11. The multi-component sponge forming silicone rubber composition according to claim 2, wherein component (G) is an organosiloxane oligomer in which the amount of silicon atom-bonded hydroxyl groups is 1 to 10 mass %.
